(19) United States
(12) Patent Application Publication
(10) Pub. No.: US 2018/0110193 A1
(43) Pub. Date: Apr. 26, 2018

(54) PLANTER CONTAINER

(71) Applicant: Andres Marmolejo, Perris, CA (US)

(72) Inventor: Andres Marmolejo, Perris, CA (US)

(21) Appl. No.: 15/334,280

(22) Filed: Oct. 25, 2016

(51) Int. Cl. A01G 27/02

(52) U.S. Cl. CPC A01G 27/02

(57) ABSTRACT

A planter container for saving water, the planter container comprises a plurality of perforations of different shapes, horizontally aligned on side walls of the container. The perforations are aligned in a specific order to retain more water by controlling unnecessary drainage of water. The planter container controls wastage of water resource by saving up to 50-90 percent of water and can be made using containers of different size and material.

### FIELD OF THE INVENTION

The present invention generally relates to planter containers or flower pots, and in particular the invention relates to planter containers comprising strategically arranged perforations for retaining water and providing ventilation, thereby promoting plant growth.

### BACKGROUND

Traditionally flower pots made from clay are used for growing and shipping plants, these flower pots possesses numerous limitations including huge water loss by evaporation, added weight and increased chances of breakage. Later, plants are grown in custom containers developed using materials like plastic, metal, wood and also using recycled materials. Conventional planters or flower pots comprises one or more holes for water drainage at the base portion of the flower pot, which results in wastage of water due to rapid or inadvertent drainage.

Further, for the plants grown in conventional flower pots with closed solid side walls, the roots doesn't receive adequate ventilation which may affect the plant growth. Drainage opening is critical for flower pots as stagnation of excessive water in containers may result breeding of insects, microbial growth, etc. On the other hand, rapid loss of moisture due to excessive draining results in drying of soil which eventually dehydrates plants thus affecting its growth and biological functions.

Therefore, there exists a need for an effective, low cost, planter container capable of retaining adequate water by controlling drainage of water from the container. There is also a need for planter containers to provide air ventilation and minimize wastage of water.

### SUMMARY OF THE INVENTION

The present invention relates to a planter container for saving water, the planter container comprises a plurality of perforations of different shapes, horizontally aligned on side walls of the container. The perforations are aligned in a specific order to retain more water by controlling unnecessary drainage of water. The planter container controls wastage of water resource by saving up to 50-90 percent of water and can be made using containers of different size and material.

In an embodiment, the planter container further comprises one or more radial grooves positioned on inner circumference of the planter. The radial grooves are configured to retain more water and oxygenize the plant grown in the planter container. The planter container is configured to decrease water usage by 90 percent.

### BRIEF DESCRIPTION OF DRAWINGS

FIG. 1 illustrates a planter container comprising a plurality of perforations.

FIG. 2 illustrates the planter container comprising perforations aligned in an order to control water drainage.

### DETAILED DESCRIPTION OF DIFFERENT EMBODIMENTS

The term “planter container”, “flower pot”, “container” and “container for growing plants” are used herein interchangeably, refers to container of any shape, size or material that can be used for growing plants.

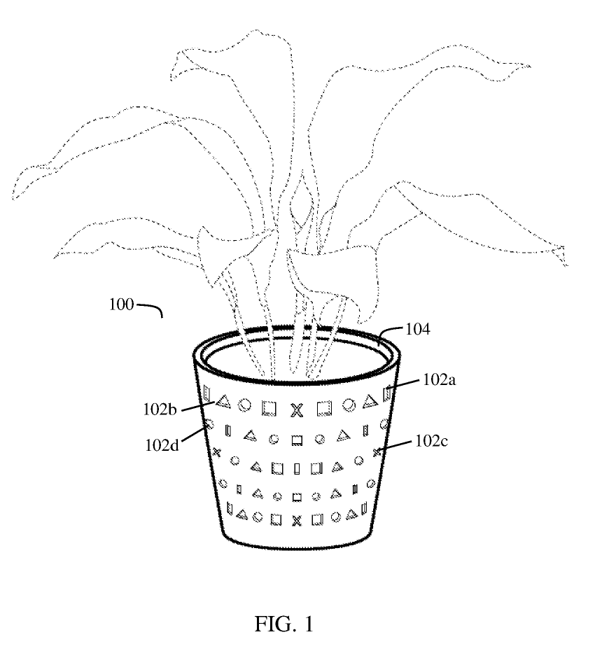

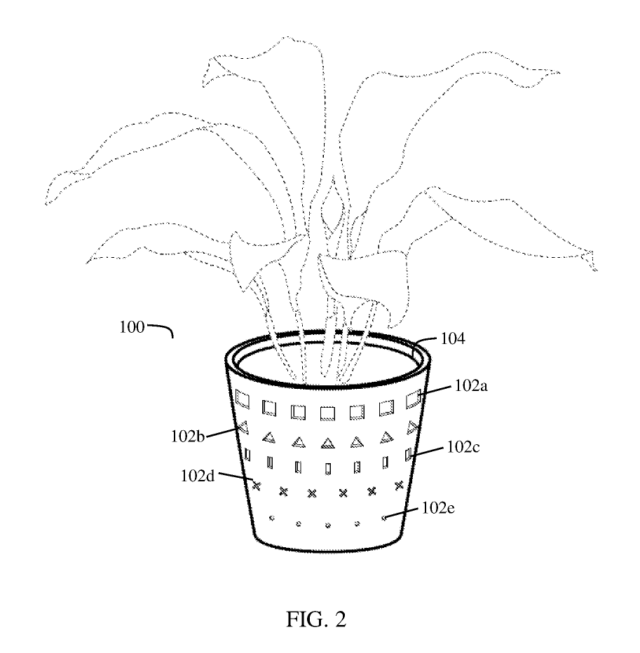

Referring to FIG. 1, the planter container 100 comprises a plurality of perforations 102a-102e, along the side walls 104 of the container 100. The perforations 102a-102e may comprises different geometrical shapes or patterns with varying sizes. FIG. 2 shows the planter container 100 comprising a plurality of perforations 102a-102e arranged across the sidewalls 104 in a specific order to control drainage of water from the container 100. For example, as shown in FIG. 2, the larger perforations 102a, 102b are horizontally arranged in the sidewalls at the top portion of the container, followed by horizontal alignment of smaller perforations 102c, 102d in the middle portion and 102e in the lower portion of the container 100. The above arrangement of perforations 102a-102e may result in drainage of stagnant water at the top portion, with gradual decrease in drainage of water towards the base portion of the container 100.

In an embodiment, the perforations 102a-102e are aligned in a specific order to retain more water by controlling unnecessary drainage of water. The planter container 100 controls wastage of water resource by saving up to 50-90 percent of water and can be made using materials of different size and type.

The planter container 100 may further comprise one or more radial grooves positioned on inner circumference of the planter. The radial grooves are configured to retain more water and oxygenize the plant grown in the planter container. The planter container 100 is configured to decrease water usage, such as for watering purpose, by 90 percent.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. A planter container comprising:
a plurality of perforations of different shapes horizontally aligned on side walls of the container, wherein the perforations are aligned in an order to control drainage of water.

2. The planter container of claim 1, comprises a flower pot.

3. The planter container of claim 1, wherein the perforations are strategically placed in a descending order based on perforation size.

4. The planter container of claim 1, further comprises radial grooves along the inner circumference of the sidewall.

5. The planter container of claim 1, is configured to save 50-90 percent of water.
